(19) United States
(12) Patent Application Publication
(10) Pub. No.: US 2012/0237661 A1
(43) Pub. Date: Sep. 20, 2012

(54) IMPREGNATED FOOD

(75) Inventors: Seiichi Fujiwara, Sakado-shi (JP); Fumito Ichikawa, Koto-ku (JP); Yutaka Kuwano, Sakado-shi (JP); Mitsunori Takahara, Koto-ku (JP)

(73) Assignee: Meiji Co., Ltd., Koto-ku, Tokyo (JP)

(21) Appl. No.: 13/502,660

(22) PCT Filed: Oct. 21, 2010
(86) PCT No.: PCT/JP2010/068592

§ 371 Date: Jun. 4, 2012

(30) Foreign Application Priority Data
Oct. 21, 2009 (JP) 2009-242065

(51) Int. Cl. A23G 3/52; A23G 3/36; A23G 1/52

(52) U.S. Cl. 426/571; 426/531; 426/631

(57) ABSTRACT

An impregnated food in which a porous solid edible material is impregnated with an air-bubble-containing food material achieves a sense of unity between the porous solid edible material and the air-bubble-containing food material, and presents unprecedented light texture and aftertaste.

### TECHNICAL FIELD

The present invention relates to a food in which a porous solid edible material is impregnated with an air-bubble-containing food material.

### BACKGROUND ART

An impregnated food obtained by bringing a porous solid edible material, such as a baked confectionery, a dried food, a freeze-dried food of meat, vegetable, fruit, etc. into contact with a liquid food before or after a pressure reduction treatment or under a condition of a reduced pressure so as to impregnate the food with the liquid food, and process for producing the same have been proposed (Patent Literatures 1 to 3). With respect to the impregnated food obtained by these processes, however, in a case where, for example, a thick porous solid edible material is impregnated with a liquid food which solidifies at room temperature, voids of the edible material are filled with the solidified liquid food, and the texture thereof becomes very hard, which is unfavorable in some occasions. To cope with this, if the impregnation is carried out at a less reduced pressure, the liquid food penetrates only to shallow zones in the porous solid edible material without reaching a central part thereof, thereby resulting in that a sense of unity between the porous solid edible material and the liquid food is impaired.

Furthermore, an impregnated food in which a porous solid edible material is impregnated with a liquid food by a first pressure reduction treatment, and then another pressure reduction treatment is carried out without immersing the porous solid edible material in the liquid food, so that the liquid food can be impregnated deep into the porous solid edible material while the liquid food inside the porous solid edible material let out moderately and a process for producing the same have been disclosed (Patent Literature 4).

With respect to the impregnated food obtained by this method, however, in a case where, for example, the viscosity of a liquid food is high, the liquid food may occasionally not be impregnated sufficiently into a porous solid edible material. Further, even if the liquid food has been able to be impregnated into the porous solid edible material by the first pressure reduction treatment, a sufficient amount of the liquid food may not be let out by the second pressure reduction treatment, and consequently, in a case where, for example, a thick porous solid edible material is impregnated with a liquid food which solidifies at room temperature, the texture thereof may become too hard. To cope with the above, if various recipe modifications are made to decrease the viscosity of a liquid food, an aimed amount of the liquid food may let out, but the taste of the liquid food may become dull, which is not favorable. Additionally, it also has a disadvantage that the steps become complicated because it is necessary to carry out the pressure reduction treatment twice.

Furthermore, a confectionery made by combining a solid edible material and an air-bubble-containing food material has also been proposed (Patent Literature 5). This confectionary is very attractive, however, because it is not made from a solid edible material in which an air-bubble-containing food material is impregnated, it lacks a sense of unity. In addition, lightness of its texture and aftertaste is not sufficient. Thus, even lighter texture and aftertaste have been demanded.

### CITATION LIST

### Patent Literature

[Patent Literature 1] WO 97/047207

[Patent Literature 2] JP 10-150917

[Patent Literature 3] JP 2001-238612

[Patent Literature 4] JP 2008-5745

[Patent Literature 5] WO 02/000032

### SUMMARY OF INVENTION

### Technical Problem

In view of this, an object of the present invention is to provide an impregnated food in which a sense of unity between a porous solid edible material and a liquid food material is attained and unprecedentedly light texture and aftertaste are provided.

### Solution to Problem

To solve the problem, the present inventors studied intensively, and found that an impregnated food in which an air-bubble-containing liquid food material is impregnated into a porous solid edible material achieves a sense of unity between the porous solid edible material and the air-bubble-containing food material and presents unprecedentedly light texture and aftertaste, completing the present invention.

The present invention is constituted by the followings:
(1) An impregnated food in which an air-bubble-containing food material is impregnated into a porous solid edible material.
(2) The impregnated food according to the above (1), wherein, by pressurizing in a state where the air-bubble-containing food material is in contact with the porous solid edible material, the air-bubble-containing food material is impregnated into the porous solid edible material and then, by returning the pressure to the atmospheric pressure to let out part of the air-bubble-containing food material impregnated into the porous solid edible material, voids are formed inside the porous solid edible material.
(3) The impregnated food according to the above (1) or (2), wherein the porous solid edible material is a baked confectionery, a puffed food or a freeze-dried food.
(4) The impregnated food according to any one of the above (1) to (3), wherein the air-bubble-containing food material is a chocolate material.
(5) The impregnated food according to any one of the above (1) to (3), wherein the air-bubble-containing food material is a marshmallow material.

### Advantageous Effects of Invention

According to an impregnated food of the present invention, since an air-bubble-containing food material is impregnated deep into a porous solid edible material, the air-bubble-containing food material impregnated has a rich taste and a sense of unity between the porous solid edible material and the air-bubble-containing food material is attained. Further, the air-bubble-containing food material impregnated has air bubbles inside, thereby presenting unprecedented light texture and aftertaste.

### BRIEF DESCRIPTION OF DRAWINGS

FIG. 1 shows a schematic diagram of a pressurization treatment method in which a compressed gas is fed into a headspace in a hermetically closed system.

FIG. 2 shows a schematic diagram of a method in which a porous solid edible material and an air-bubble-containing food material are placed in a deformable hermetically closed container, and the deformable container is pressurized from its surroundings by a compressed gas or a compressed liquid.

FIG. 3 shows a schematic diagram of a method in which an air-bubble-containing food material in which a porous solid edible material is immersed is pressurized directly.

### DESCRIPTION OF EMBODIMENTS

In the present invention, there is no particular restriction on the porous solid edible material insofar as the food is porous and has voids therein. Examples thereof include freeze-dried products of fruits, vegetables, sea foods, meats, eggs, molded foods (molded using various raw materials), and the like; various puffed foods, such as puffed snack foods produced by deep-frying with oil, by puffing pellets with hot air, or by cooking and puffing a raw material by an extruder; and baked confectioneries, such as rice crackers (senbei), small rice crackers (arare), millet-and-rice cakes (okoshi), small sugar-coated cookies (karintou), wafers, croutons, meringues, biscuits, pies, cookies, and sponge cakes. Other examples include breads such as white bread and French bread, doughnuts, waffles, freeze-dried tofu, and dried wheat gluten (fu).

The air-bubble-containing food material to be impregnated into the porous solid edible material according to the present invention includes any and all edible materials which are fluent at impregnation and capable of containing air bubbles. Furthermore, the air-bubble containing food material may be solidified in the impregnated food. Consequently, examples of the air-bubble-containing food material include butter, margarine, chocolate, gummi candies, candies, and marshmallow.

Other examples of the air-bubble-containing food material to be impregnated into the porous solid edible material include slurries or oil-based creams, in which solids (e.g., sugar, cacao mass, tea leaves, powdered milk, freeze-dried foods, dried cheeses, various dried powders, and various spices) are dispersed in oils and fats; solutions in which various thickening polysaccharides (such as agar, carrageenan, guar gum, xanthan gum, tamarind gum, and pectin) are dissolved; and fresh cream.

A value of a pressure (kPa) herein means an absolute pressure value, which is a sum of an environmental pressure such as the atmospheric pressure and a pressure intentionally added. The pressure measurement herein is conducted in an environment of 1 atm. In an environment at 1 atm, if no pressure is intentionally added, the pressure value is 101 kPa.

The term chocolate is used herein in a broad sense, and not restricted by the “Fair Competition Code for Proper Labeling of Chocolate Products” certified by the Japan Fair Trade Commission. Namely, it is a food suspending an edible component, such as a cocoa powder, a finely-milled powder of saccharides or milk solids, in a matrix consisting of a continuous phase of an edible oil and fat solidifying at a certain temperature or below, and optionally various emulsifiers, additives, flavors, etc. may be added. Typical Examples include dark chocolate, milk chocolate and white chocolate. Furthermore, the edible oil and fat is not limited to cocoa butter, and chocolate using as cocoa butter equivalents an oils and fats, such as tempering oils or a non-tempering oils derived from animals or plants, or also a mixture of the equivalents and cocoa butter, is included in the chocolate according to the present invention.

(Production Process)

An impregnated food according to the present invention can be obtained in such a manner that, in a hermetically closed system, the system is pressurized in a state where a porous solid edible material is made contact with an air-bubble-containing food material, and then the pressure in the system is reduced. The contact includes a partial contact, but is preferably an entire contact.

The impregnated food according to the present invention can be obtained, for example, in such a manner that the pressure is increased in a state where the porous solid edible material is completely immersed in the air-bubble-containing food material and the pressurized state is maintained for a certain period (step 1), and then the pressure is returned to the atmospheric pressure (step 2). Each step will be described in more detail below.

(Step 1)

At the first pressurization treatment, it is not necessary that the porous solid edible material be completely immersed in an air-bubble-containing food material, but if part of the porous solid edible material is not immersed in the air-bubble-containing food material, the air-bubble-containing food material is not sufficiently impregnated into that part. In view of this, it is preferable that the treatment is carried out in a state in which the porous solid edible material is completely immersed in the air-bubble-containing food material.

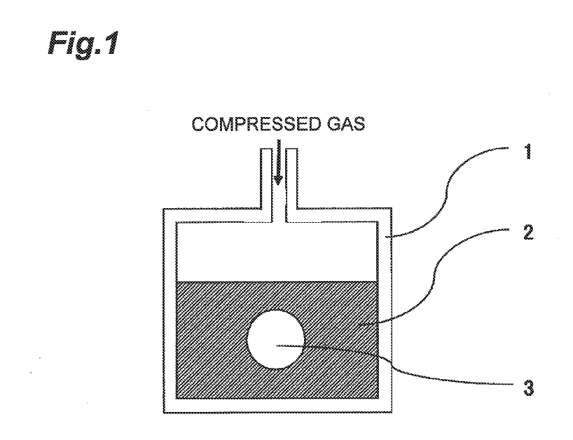

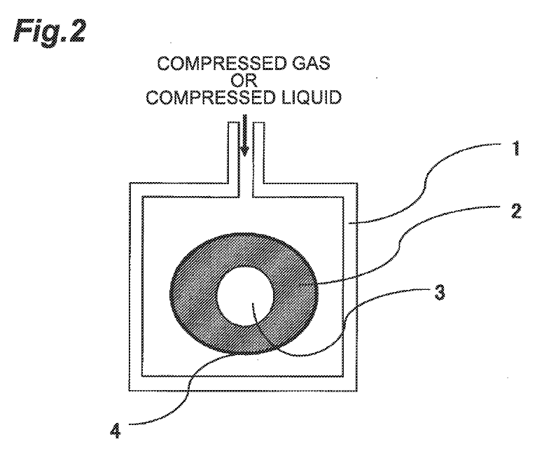

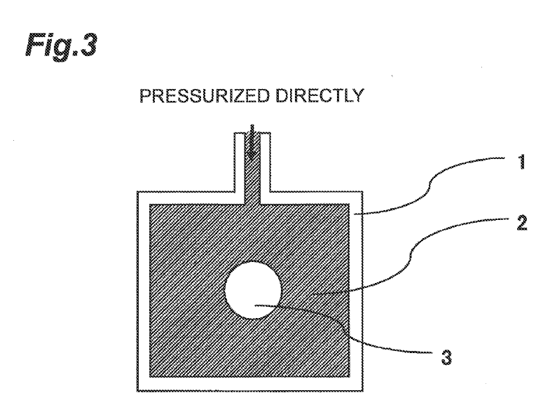

There is no particular restriction on a pressurization method, insofar as the air-bubble-containing food material can be pressurized. As a pressurization treatment, for example, any of a method in which a compressed gas is fed into a headspace in a hermetically closed system (FIG. 1), a method in which a porous solid edible material and an air-bubble-containing food material are placed in a deformable hermetically closed container, and the deformable container is pressurized from the surroundings by a compressed gas or a compressed liquid (FIG. 2), and a method in which an air-bubble-containing food material in which a porous solid edible material is immersed is pressurized directly (FIG. 3) may be carried out.

By the pressurization treatment, the air-bubble-containing food material is impregnated from the surface of the porous solid edible material inward toward the center, and at the same time air originally existing in the porous solid edible material is compressed inward toward the central part. The higher the pressure applied to the air-bubble-containing food material, the closer to the center of the porous solid edible material the air-bubble-containing food material can be impregnated. In a case where the viscosity of the air-bubble-containing food material is high, the structure of the porous solid edible material is compact, or the volume of the porous solid edible material is large, it tends to become difficult to impregnate the air-bubble-containing food material close to the center of the porous solid edible material. It is, however, possible by intensifying appropriately the pressurization to impregnate the food material close to the center. The maximum pressure during the pressurization is preferably an absolute pressure of 200 kPa to 10130 kPa and may be selected according to a combination of the porous solid edible material and the air-bubble-containing food material.

On the other hand, in a conventional method of impregnating the air-bubble-containing food material by pressure reduction, even if the pressure is reduced close to the absolute vacuum, only a differential pressure of 101.3 kPa is produced at a maximum, and consequently under such difficult conditions for impregnation as described above, impregnation close to the center may occasionally not be possible. Furthermore, because air bubbles in the air-bubble-containing food material are released from the material in the pressure reduction process, the impregnated food obtained is caused to contain no air bubbles.

At the step 1, as soon as a predetermined pressure is reached, the step 2 may be initiated; or after a predetermined pressure is maintained for a certain period of time, the step 2 may be initiated.

(Step 2)

The step of returning the pressure to the atmospheric pressure after pressurization is carried out by releasing the pressure, in a case where the pressurization is carried out by means of a compressed gas or a compressed liquid. Furthermore, in a case where the air-bubble-containing food material is pressurized directly by a pressing body, the step of returning the pressure to the atmospheric pressure is carried out by releasing the pressure of the pressing body. The step of returning the pressure to the atmospheric pressure may be carried out in a state where the porous solid edible material is immersed in an air-bubble-containing food material, or in a state where the porous solid edible material is out of contact with the air-bubble-containing food material. In either cases, the air compressed close to the center of the porous solid edible material expands when returning to the atmospheric pressure, thereby letting out part of the impregnated air-bubble-containing food material. Through the above, an impregnated material having moderate voids inside the porous solid edible material can be obtained. These moderate voids, coupled with the air bubbles in the air-bubble-containing food material, give the impregnated material light texture. The expanding force of the air compressed in the central part of the porous solid edible material increases in response to the intensity of the compression. In a case where the viscosity of the air-bubble-containing food material is high, the structure of the porous solid edible material is compact, or the volume of the porous solid edible material is large, it tends to become difficult to let out the air-bubble-containing food material, but it is still possible to let out the air-bubble-containing food material by intensifying the pressurization. In this connection, as for a speed of returning to the atmospheric pressure, in a case where the pressure is returned from the pressurized state to the atmospheric pressure too rapidly, the porous solid edible material may be broken, and therefore, the speed must be controlled appropriately.

The impregnated food obtained by the afore-described procedures may be cooled down to solidify the impregnated air-bubble-containing food material. Further, as needed, additional processing, such as coating and topping, may be carried out according to known methods.

### EXAMPLES

The present invention will be described in more detail below referring to Examples, but the present invention is not limited thereto.

### Example 1

A liquid batter was prepared by mixing well 230 parts by weight of chicken eggs, 170 parts by weight of sugar, 90 parts by weight of an emulsified oil and fat, 3 parts by weight of an emulsifier, 150 parts by weight of water, 300 parts by weight of cake flour, and 30 parts by weight of an oil and fat. The material was flowed into a metal mold, baked in an oven at 180° C. for 20 min, and further dried at 100° C. for 1 hour to obtain baked confectioneries in a size of 30 mm×20 mm×150 MM.

A chocolate material was prepared by a conventional method with the formulation of 400 parts by weight of sugar, 340 parts by weight of cacao mass, 150 parts by weight of cocoa butter, 100 parts by weight of vegetable oil and fat, and 12 parts by weight of an emulsifier. 100 parts by weight of the chocolate material was adjusted to 35° C. in temperature, mixed with 3 parts by weight of Chocoseed B (produced by Fuji Oil Co., Ltd.), and then adjusted to 28° C. in temperature before being aerated to a specific gravity of 0.78 in a whipper (Kenmix Aicoh PRO KM-600 (produced by Aicohsha Manufacturing Co., Ltd)).

The baked confectioneries were immersed in the aerated chocolate, and they were placed in a hermetically closed container. After compressed air was fed to a space in the hermetically closed container to increase the pressure to +600 kPa (an absolute pressure of 701 kPa), the pressure was maintained for 10 sec, and then reduced to the atmospheric pressure. Thereafter, the baked confectioneries were taken out from the chocolate material, the chocolate material attached around the baked confectioneries was wiped off thoroughly, and the baked confectioneries were cooled down to 15° C. to solidify the chocolate to obtain baked confectioneries impregnated with an aerated chocolate material.

The confectioneries obtained had a rich flavor of an air-bubble-containing chocolate material and a sense of unity between the chocolate material and the porous baked confectioneries. Furthermore, because the impregnated chocolate material contained air bubbles, the confectioneries had unprecedented light texture and aftertaste.

### Comparative Example 1

The same operation as in Example 1 was performed except a chocolate material was used without aeration to obtain baked confectioneries into which the chocolate material was impregnated. The confectioneries obtained had moderate voids and the chocolate material was impregnated to their center, however, they were clearly inferior to the confectioneries obtained in Example 1 in lightness of texture and aftertaste.

### Example 2

Commercially available bread was dried at 100° C. for two hours and then cut to 20 mm×10 mm×20 mm in size to prepare dried bread materials.

Furthermore, 390 parts by weight of sugar, 400 parts by weight of starch syrup, 30 parts by weight of starch, 110 parts by weight of water were boiled down, and then 60 parts by weight of 33% by weight of gelatin solution was mixed (compound liquid of gelatin solution and other). The compound liquid was aerated using a whipping mixer to a specific gravity of 0.7 to prepare a marshmallow material of B×78 and 60° C. in temperature.

In the marshmallow material obtained, the dried bread materials were immersed, and they were placed in a hermetically closed container. After compressed air was fed to a space in the hermetically closed container to increase the pressure to +600 kPa (an absolute pressure of 701 kPa), the pressure was maintained for 10 sec, and then reduced to the atmospheric pressure. Thereafter, the dried bread materials were taken out from the marshmallow material, the marshmallow material attached around the dried bread materials was wiped off thoroughly, and the dried bread materials were cooled down to 20° C. to be set to obtain impregnated confectioneries.

The confectioneries obtained had a rich flavor of the marshmallow material impregnated and a sense of unity between the marshmallow material and the dried bread materials. Furthermore, because the impregnated marshmallow material contained air bubbles, the confectioneries obtained had unprecedented light texture and aftertaste.

### Comparative Example 2

The same operation as in Example 2 was performed except compound liquid of gelatin solution and other was used without aeration to obtain impregnated confectioneries into which gelatin gel was impregnated. The confectioneries obtained had moderate voids and the gelatin gel was impregnated to their center, however, they were clearly inferior to the confectioneries obtained in Example 2 in lightness of texture and aftertaste.

### REFERENCE SIGNS LIST

1: Hermetically closed container, 2: Air-bubble-containing food material, 3: Porous solid edible material, 4: Deformable hermetically closed container.

1. An impregnated food in which a porous solid edible material is impregnated with an air-bubble-containing food material.

2. The impregnated food according to claim 1, wherein, by pressurizing in a state where the air-bubble-containing food material is in contact with the porous solid edible material, the air-bubble-containing food material is impregnated into the porous solid edible material and then, by returning the pressure to the atmospheric pressure to let out part of the air-bubble-containing food material impregnated into the porous solid edible material, voids are formed inside the porous solid edible material.

3. The impregnated food according to claim 1, wherein the porous solid edible material is a baked confectionery, a puffed food or a freeze-dried food.

4. (canceled)

5. (canceled)

6. The impregnated food according to claim 2, wherein the porous solid edible material is a baked confectionery, a puffed food or a freeze-dried food.

7. The impregnated food according to claim 1, wherein the air-bubble-containing food material is a chocolate material.

8. The impregnated food according to claim 2, wherein the air-bubble-containing food material is a chocolate material.

9. The impregnated food according to claim 3, wherein the air-bubble-containing food material is a chocolate material.

10. The impregnated food according to claim 6, wherein the air-bubble-containing food material is a chocolate material.

11. The impregnated food according to claim 1, wherein the air-bubble-containing food material is a marshmallow material.

12. The impregnated food according to claim 2, wherein the air-bubble-containing food material is a marshmallow material.

13. The impregnated food according to claim 3, wherein the air-bubble-containing food material is a marshmallow material.

14. The impregnated food according to claim 6, wherein the air-bubble-containing food material is a marshmallow material.
